(19) United States
(12) Patent Application Publication
(10) Pub. No.: US 2010/0010824 A1
(43) Pub. Date: Jan. 14, 2010

(54) RECOMMENDATION SYSTEM FOR USER'S DECISION ABOUT THE SHARING OF PRIVATE INFORMATION TO OTHER PARTY AND METHOD THEREOF

(75) Inventors: Seunghyun KIM, Daejeon-city (KR); Seunghun JIN, Daejeon-city (KR); Jinman CHO, Daejeon-city (KR); Youngseob CHO, Daejeon-city (KR); Sangrae CHO, Daejeon-city (KR); Daeseon CHOI, Daejeon-city (KR); Jonghyouk NOH, Daejeon-city (KR); Soohyung KIM, Daejeon-city (KR); Kwansoo JUNG, Daejeon-city (KR); Deokjin KIM, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/499,969

(22) Filed: Jul. 9, 2009

(30) Foreign Application Priority Data
Jul. 9, 2008 (KR) 10-2008-0066510

(51) Int. Cl. G06Q 99/00; G06F 15/16

(52) U.S. Cl. 705/1; 709/203

(57) ABSTRACT

The present invention proposes a method of providing recommendation information to help user's decision about what private information to share from a service provider in a user-centered ID management environment. The present invention provides recommendation information to help appropriate user's decision about what private information to share from the service provider to a user, such that the user can more reasonably make a decision based on the recommendation value.

### RELATED APPLICATIONS

The present application claims priority to Korean Patent Application Serial Number 10-2008-0066510, filed on Jul. 9, 2008, the entirety of which is hereby incorporated by reference.

### BACKGROUND OF THE INVENTION

1. Field of the Invention

The present invention relates to a recommendation system for user's decision about the sharing of private information to other party and a method thereof, and more specifically, to a recommendation system to help user's decision when the user shares private information according to a private information request from a service provider in a user-centered ID environment and a method thereof.

2. Description of the Related Art

Today, after a user provides private information, such as his/her resident registration number, etc., and generates an ID on service provider sites, he/she uses his/her IDs for each site to perform a log-in in order to use the sites' services. However, this scheme can degrade user convenience, increase the risk of hacking of private information and the invasion of privacy, and increase the misuse and abuse of private information accumulated by an individual service provider, there is a problem in that it is inappropriate for a web 2.0 environment, where users commonly share and participate in said environment.

As an alternative to this scheme, a user-centered ID management scheme, which locates a user in the center of all transactions to control the sharing of private information, has been disclosed.

Unlike the existing ID environment that allows the service provider to manage the private information of the user, the user-centered ID management environment can enable the user to directly hold private information or directly control the use of private information that is held by the service provider. Therefore, the user can control his/her private information and expose only desired private information at his/her desired time point, thereby making it possible to enhance the user's privacy.

The foregoing user-centered ID management scheme has an advantage that can widen the options for the user, but has a disadvantage in that there are too many options for the user.

Further, since the user-centered ID management scheme does not provide detailed information that enables the user to make the most appropriate decision during the process of decision, such as when the user shares his/her private information, there is a problem in that the user, who may not be familiar with the use of Internet, may make the wrong decision to inappropriately provide his/hers private information. For example, the user may provide his/her private information, which has nothing to do with the service provided by the service provider, to the service provider. Further, since the existing user-centered ID management scheme demands the user makes a selection every time, inconvenience to the user is increased, such that there is a problem in that the user is may easily miss portions to which the user should pay attention.

### SUMMARY OF THE INVENTION

The present invention proposes to solve the above problems. It is an object of the present invention to provide a system of providing recommendation information to help user's decision about a private information request from a service provider so as to allow the user to accurately determine whether he/she needs to provide his/her private information to the service provider, what kind of private information he/she will provide, etc., when the service provider requests private information of the user and what private information to share and a method thereof.

There is provided a method of providing recommendation information to a user that wants to share private information including: allowing a recommendation provider server to receive a recommendation request message including a list of the private information of the user requested by a service provider server and identity information of the service provider server from a client; allowing the recommendation provider server to analyze the received recommendation request message and generate recommendation information to help perform the user response to the private information request from the service provider server; and allowing the recommendation provider server to send the generated recommendation information to the client.

In particular, generating recommendation information received from the client, a response pattern of the user in respects to the private information request from the service provider server to reflect the personal intention of the user based on the response pattern of the user and then generating the recommendation information.

Also, generating recommendation information includes allowing the recommendation provider server to analyze the level of reliability of the service provider based on the identity information of the received service provider and calculate recommendation values corresponding to the analyzed the level of reliability; and allowing the recommendation provider server to analyze a degree of exposure of the private information of the user based on the received list of the private information and calculate recommendation values corresponding to the analyzed degree of exposure.

Further, the recommendation request message further includes a request purpose of private information from the service provider server and generating recommendation information further includes analyzing whether the private information of the user requested by the service provider server meets the service purpose provided by the service provider server based on the recommendation request message and calculating recommendation values corresponding thereto.

In addition, there is provided a method of providing recommendation information to a user that wants to share private information, including: allowing a client to send a recommendation request message including a list of private information requested by a service provider server and identity information of the service provider server to a recommendation provider server and request the recommendation information; allowing the client to receive the recommendation information from the recommendation provider server and display the identity information of the service provider server together with various types of private information selected by the user; and allowing the client to send the selected private information to the service provider server according to the user response.

In particular, the method further includes allowing the client to send the private information to the service provider server and then send the response pattern of the user to the recommendation provider server.

Further, the client stores and manages the response pattern of the user.

Moreover, there is provided a system of providing recommendation information to a user that wants to share private information, including: an interaction unit that transmits a recommendation request message including a list of the private information of a user requested by a service provider server and identity information of the service provider server to a recommendation provider server and receives the recommendation information from the recommendation provider server; and an identity selector that provides the recommendation information together with the identity information of the service provider server and various types of private information selectable by the user to the user.

In particular, the identity selector selects any one type of private information without the user response based on the recommendation information and transmits the selected private information to the service provider server.

Further, the system further includes an identity providing unit that provides private information of the user to the identity selector according to the request of the identity selector.

In addition, the identity providing unit stores and manages false private information.

Also, there is a provided a system of providing recommendation information to a user that wants to share private information, including: a service provider reliability analyzer that receives the identity information of the service provider server from a client, analyzes the level of reliability of the service provider based on the received identity information, and calculates recommendation values corresponding to the analyzed level of reliability; and a privacy analyzer that receives a list of the private information of the user requested by the service provider server from the client, analyzes a degree of exposure of the private information of the user based on the list, and calculates recommendation values corresponding to the analyzed degree of exposure.

In addition, the system of providing recommendation information to a user that wants to share private information, further includes: a request compatibility analyzer that receives a request purpose of the private information of the service provider server from the client, analyzes a correlation between it and a list of the private information of the user requested by the service server provider server, and calculates recommendation values corresponding thereto.

Moreover, the system further includes a response pattern analyzer that receives, from the client, the response pattern of the user to the private information request from the service provider server and analyzes the response pattern of the user.

According to the present invention, the following effects can be achieved.

The present invention provides recommendation information to help appropriate user's decision about what private information to share from the service provider to a user, such that the user can more reasonably make a decision base on the recommendation value.

### BRIEF DESCRIPTION OF THE DRAWINGS

FIG. 1 is a diagram for schematically explaining a system of providing recommendation information to a user, who wants to share private information, according to one embodiment of the present invention;

FIG. 2 is a diagram for explaining in detail a client and a recommendation provider server according to one embodiment of the present invention;

FIG. 3 is a diagram for explaining a detailed function of an identity selector of the client shown in FIG. 2;

FIG. 4 is a diagram for explaining a process of allowing the client to send the private information to a service provider server based on the recommendation information from the recommendation provider server according to one embodiment of the present invention; and

FIG. 5 is a diagram for explaining a process of transmitting the private information to the service provider server based on the recommendation information from the recommendation provider server according to one embodiment of the present invention.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension.

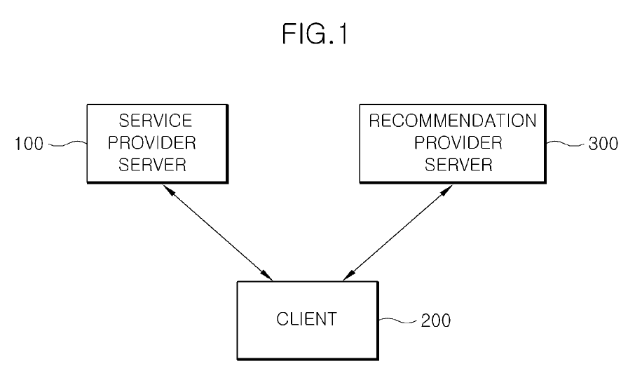

FIG. 1 is a diagram for schematically explaining a system of providing recommendation information to a user that wants to share private information, according to one embodiment of the present invention.

According to one embodiment of the present invention, a system of providing recommendation information to a user that wants to share private information includes a service provider server 100, a client 200, and a recommendation provider server 300.

The service provider server 100 is a service provider side apparatus that provides predetermined services to a user that uses internet access devices such as a mobile terminal, a desk top, a notebook computer, etc. For example, the service provider server 100 may be an internet portal server, a game server, etc. The service provider server 100 requests private information, which is required to provide the predetermined service to the user, to the client 200. Upon requesting the private information, the service provider server 100 transmits its own identity information, a list of the requested private information, and information including a request purpose, etc., to the client. And, the service provider server 100 receives and verifies the private information of the user requested by the service provide server 100 from the client 200, and when the private information meets predetermined requirements, provides the predetermined services to the client 200. At this time, when the private information of the user received from the client 200 does not meet the predetermined requirements, the service provider server 100 does not provide the predetermined services and outputs an error message.

The client 200 is provided between the service provider server 100 and the recommendation provider server 300. The client 200 displays a list of the private information requested by the service provider server 100 to the user and displays the recommendation information received from the recommendation provider server 300 to the user. In the present invention, the client 200 directly stores the private information of the user corresponding to the list of the private information requested by the service provider server 100 therein or can bring it from a trusted third party (TTP).

The client 200 may be an internet access device such as a mobile terminal, a desk top, etc. For example, the mobile terminal means a personal internet access device such as a personal mobile phone, a PDA, etc. The client 200 supports user registration and authentication in the service provider server 100. More specifically, the client 200 displays the list of private information requested by the service provider server 100, the identity information of the service provider server 100, and the information including the request purpose, etc., or receives the selection of the user. In addition, the client 200 displays the recommendation information received from the recommendation provider server 300, performs a role of querying whether the user provides private information corresponding to the list of private information requested by the service provider server 100, and receives the selection of the user according thereto.

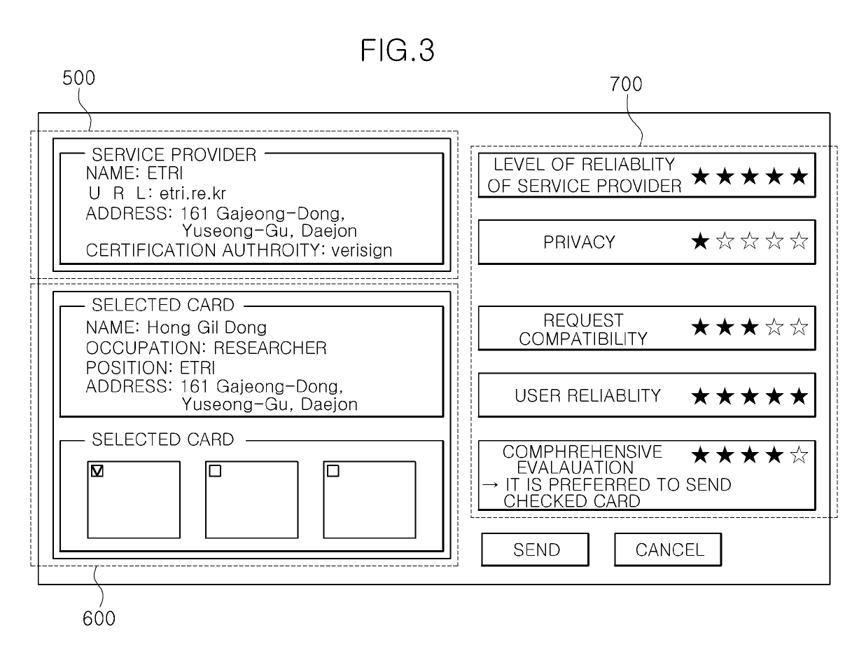

The recommendation provider server 300 receives the identity information of the service provider server 100, the list of private information requested by the service provider server 100, and the information (hereinafter, ‘recommendation request message’) including a request purpose of the private information of the service provider server 100, etc., from the client 200, generates the recommendation information based on them, and provides it to the client 200. At this time, the recommendation information is information to help the user correctly respond to the private information request from the service provider server 100. In other words, the recommendation information is information provided to the user to allow the user to accurately determine whether he/she provides his/her private information to the service provider server 100, what kind of private information he/she will provide, etc. The recommendation provider server 300 can apply various methods to generate the recommendation information. For example, there may be a method that subdivides the provided information to allocate recommendation values for each case and applies a predetermined algorithm thereto, thereby generating final recommendation values. A detailed method of generating the recommendation information in the recommendation provider server 300 will be described below with reference to FIG. 3.

Meanwhile, the recommendation provider server 300 may be implemented in various forms. In one embodiment of the present invention, as shown in FIG. 1, the client 200 and the recommendation provider server 300 are configured as a physically separate system, but the present invention is not limited thereto. In other words, the recommendation provider server 300 is implemented in a module form, such that it may be inside the client 200.

Hereinafter, the present invention will be described under the assumption that the client 200 and the recommendation provider server 300 are configured as a physically separate system.

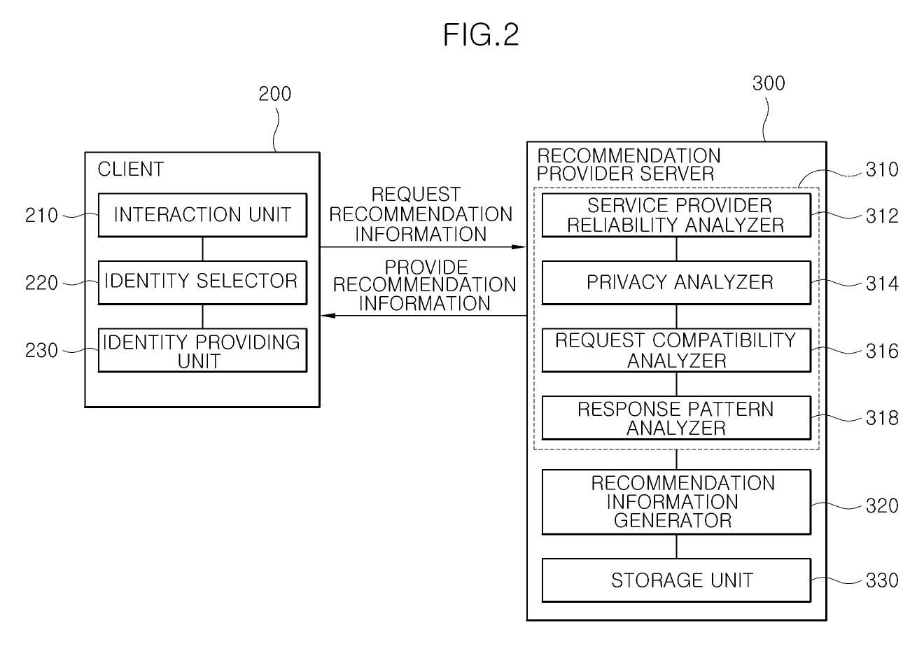

FIG. 2 is a diagram for explaining in detail the client and the recommendation provider server according to one embodiment of the present invention and FIG. 3 is a diagram for explaining a detailed function of an identity selector of the client shown in FIG. 2.

The client 200 according to one embodiment of the present invention includes an interaction unit 210, an identity selector 220, and an identity provider 230.

And, the recommendation provider server 300 according to one embodiment of the present invention includes an analyzer 310, a recommendation information generator 320, and a storage unit 330. And, the analyzer 310 includes a service provider reliability analyzer 312, a privacy analyzer 314, a request compatibility analyzer 316, and a response pattern analyzer 318.

Hereinafter, operations and functions of the client 200 will first be described in detail.

The interaction unit 210 performs a role of requesting the recommendation information to the recommendation provider server 300 between the identity selector 220 and the recommendation provider server 300 or receiving the recommendation information from the recommendation provider server 300. In other words, the interaction unit 210 performs a role of requesting the recommendation information to the recommendation provider server 300 or transmitting the response (for example, ‘recommendation information’) from the recommendation provider server 300 to the identity selector 220. Further, the interaction unit 210 stores and manages the response pattern of the user to the response from the recommendation provider server 300. The interaction unit 210 provides the response pattern of the user to the recommendation provider server 300, thereby making it possible to receive the recommendation information specialized (i.e., reflecting personal intention) for each user from the recommendation provider server 300. Further, the interaction unit 210 provides the response pattern of the user to the identity selector 220 and the identity selector 220 can automate the user response to the response from the recommendation provider server 300 by using the response pattern of the user provided from the interaction unit 210.

The identity selector 220 selects the private information of the user stored in the identity providing unit 230 based on the user response and provides it to the service provider server, in order to receive predetermined services, which are provided by the service provider, from the service provider server. To this end, the identity selector 220 transmits the identity information of the service provider server 100, the list of private information requested by the service provider server 100, and the recommendation request message including the request purpose of the private information of the service provider server 100 to the recommendation provider server 300 through the interaction unit 210. Further, as shown by reference numeral 500 of FIG. 3, the identity selector 220 displays the identity information of the service provider, etc., such that the user can confirm the identity information of the service provider.

Moreover, as shown by reference numeral 700 of FIG. 3, the identity selector 220 displays the response (for example, ‘recommendation information’ from the recommendation provider server 300, such that the user can determine whether he/she shares his or her private information by referring to the response. By the above configuration, the user can accurately determine whether he/she provides his/her private information to the service provider, what kind of private information he/she will provide, etc., as well as expose only appropriate private information at his/her desired point in time, thereby making it possible to enhance the user's privacy. Meanwhile, when the user completely trusts the recommendation information provided by the recommendation provider server 300, the identity selector 220 automates the user response with respect to the response from the recommendation provider server 300 based on the response history of the user provided from the interaction unit 210. At this time, the user response means the user response to the request of the service provider server.

Further, as shown by reference numeral 600 of FIG. 3, the identity selector 220 enables the user to select one among the various private information. For example, various private information may include private information directly prepared by the user, private information obtained from trusted organizations, false information, etc. Therefore, the user can provide the private information having high reliability when the recommendation value of the recommendation information provided from the recommendation provider server 300 is high and the false private information to the service provider server 100 when the recommendation value provided is low.

The identity providing unit 230 stores and manages the private information of the user and upon requesting, provides it to the identity selector 220. Herein, the private information of the user may be implemented by a metaphor including a card type as shown by reference numeral 600 of FIG. 3. Meanwhile, the identity providing unit 230 is implemented inside the client 200 in FIG. 2, but is not limited thereto. Therefore, the identity providing unit 230 may be positioned outside the client 200. In this case, a predetermined request/response protocol may be required for communicating with the client 200.

Next, operations and functions of the recommendation provider server 300 will be described in detail.

The recommendation provider server 300 according to one embodiment of the present invention includes an analyzer 310 that receives the list of private information requested by the service provider server 100, the identity information of the service provider server 100, and the information including the request purpose, etc., comprehensively analyzes a degree of recommendation of the service provider server 100 based on them in a technical aspect and a social aspect, and derives the result values, a recommendation information generator 320 that generates the recommendation information to be provided to the client 200 based on the result values analyzed in the analyzer 310, and a storage unit 330 that stores essential data to operate each component described above.

First, the analyzer 310 includes the service provider reliability analyzer 312, a privacy analyzer 314, a request compatibility analyzer 316, and a response pattern analyzer 318.

The service provider reliability analyzer 312 objectively analyzes the level of reliability of the service provider server 100, that is, the level of reliability of the service provider (site) based on the identity information of the service provider server 100 included in the recommendation request message from the client 200 and calculates the recommendation values. The service provider may be subdivided based on various criteria. For example, the service provider may be subdivided based on which country it belongs to, company size, whether it is a public institution, whether it is nonprofit, a security level of a service provider site, etc. The service providers are divided by the predetermined criteria and the service provider reliability analyzer 312 discriminately gives the level of reliability to each service provider. And, the service provider reliability analyzer 312 calculates the recommendation value to be provided to the client 200 based on the given level of reliability.

The privacy analyzer 314 objectively analyzes the degree of exposure of the private information of the user based on the recommendation request message from the client 200 and calculates the recommendation value. For example, providing private information, such as sex, age, taste, etc., is low in terms of the degree of exposure of the private information. In other words, it does not significantly invade the user's privacy. However, providing a name, an address, a telephone number, etc., exposes private information, such that the user's privacy can be significantly invaded. Further, the more the items of the requested private information in the list of the private information requested by the service provider server 100, the larger the degree of exposure of the private information can be increased. The degree of exposure of the private information can be provided by the predetermined criteria and the privacy analyzer 314 calculates the recommendation value to be provided to the client 200 based on the degree of exposure of the private information of the user.

The request compatibility analyzer 316 comprehensively analyzes the correlation between the request purpose included in the recommendation request message and the list of the requested private information and calculates the recommendation values. For example, in the case of an Internet shopping mall, since articles ordered by the user should be delivered to home, the user should provide his/her name, home address, telephone number, etc., to the service provider so that the user can obtain the desired service. In the foregoing case, since the service provider requests the private information having a high correlation with the service purpose of the service provider, the recommendation value calculated by the request compatibility analyzer 316 is increased. On the other hand, when the service provider requests the private information having a low correlation with the service purpose of the service provider, the recommendation value calculated by the request compatibility analyzer 316 is reduced. In other words, in the service provider providing services to the user, even when it does not necessarily need the address or resident registration number of the user, if it requests the private information, the recommendation value calculated by the request compatibility analyzer 316 can not help be reduced.

The response pattern analyzer 318 refers to the recommendation values received from the recommendation provider server 300 and receives the response pattern of the user from the interaction unit 210 of the client 200 when the user provides the private information to the service provider server 100 (that is, when the user performs the response), thereby analyzing the response pattern of the user. Thereafter, when the recommendation information is requested from the client 200, the recommendation information reflecting the personal intention of the user is provided based on the analyzed response pattern of the user. For example, in order for any user to receive services associated with specific fields provided by the specific service provider, the user may provide his/her personal information to the specific service provider regardless of various recommendation values (that is, the degree of exposure of the private information, the correlation between the service purpose of the service provider and the private information, or the level of reliability of the service provider) or the comprehensive recommendation values proposed by the recommendation provider server 300. This may correspond to a case where the user individually trusts the specific sites or doesn't have a large interest in the exposure of his/her private information. Therefore, the response pattern analyzer 318 of the present invention continuously and comprehensively analyzes the response pattern of the user, thereby making it possible to calculate the recommendation information reflecting the personal intention of the user.

Further, the response pattern analyzer 318 analyzes the level of reliability of the users on the specific service provider and calculates the recommendation value. When the users provide the trusted private information to the specific site, the level of reliability of the user on the specific service provider is increased. The response pattern analyzer 318 analyzes the previous response pattern of the users and analyzes the user reliability to the specific service provider, thereby calculating the recommendation values based thereon.

The recommendation information generator 320 generates the recommendation information including the comprehensive recommendation values calculated in the analyzer 310 and provides it to the client 200.

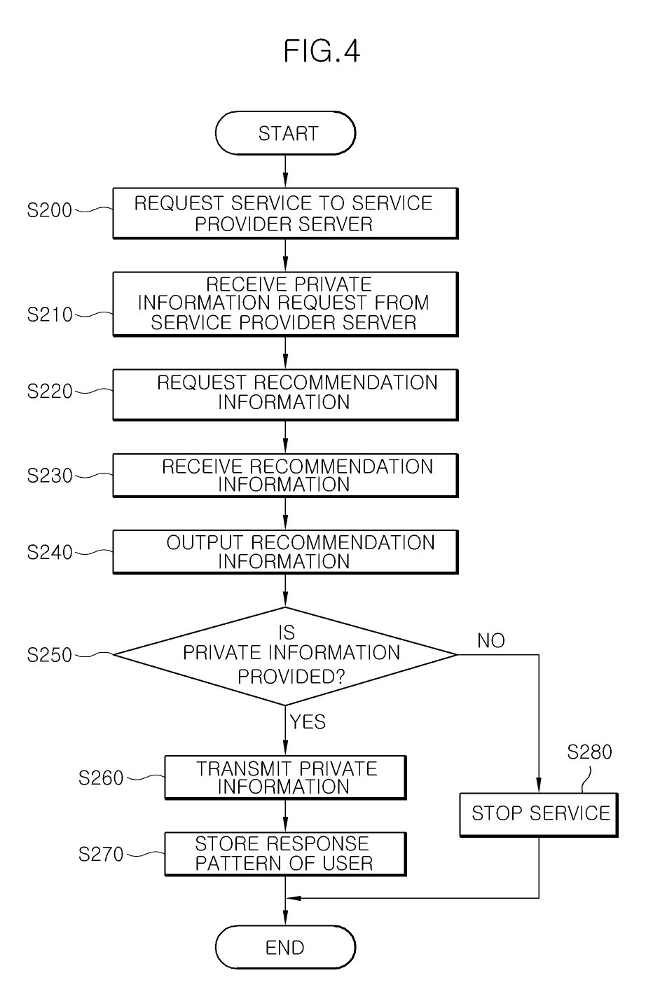

FIG. 4 is a diagram for explaining a process of allowing the client to send the private information to the service provider server based on the recommendation information from the recommendation provider server according to one embodiment of the present invention.

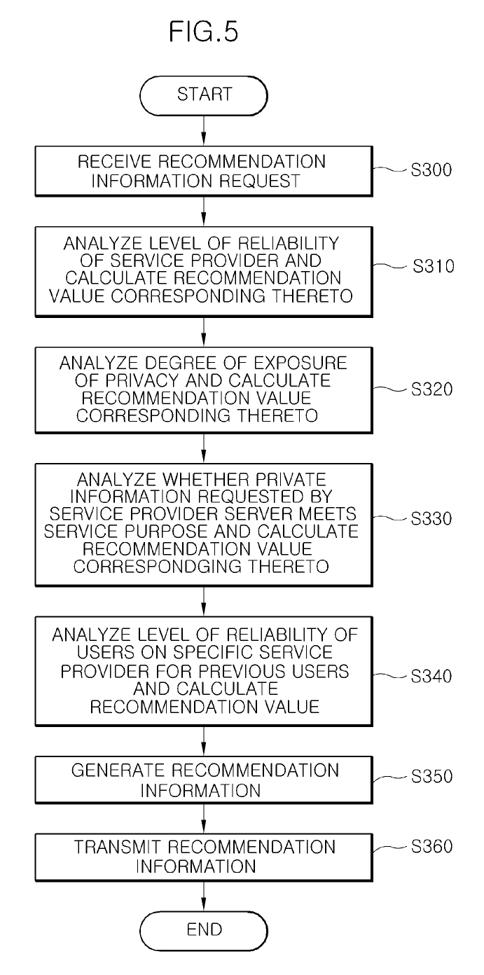

First, the client requests the specific services to the service provider server 100 and the service provider server 100 receives them (S₂₀₀). Next, the service provider server 100 requests the private information of the user, which is required to provide the corresponding specific service, to the client 200. At this time, when the service provider server 100 requests the private information of the user to the client 200, it transmits its own identity information, the information including the request purpose, etc., together. When the client 200 receives the corresponding request, it transmits the list of the private information, its own identity information, the information including the request purpose, etc., which are received from the service provider server 100, to the recommendation provider server 300 and requests the recommendation provider server to provide the recommendation information (S210 and S220). Therefore, the recommendation provider server 300 generates the recommendation information according to the recommendation information request from the client 200 and provides it to the client 200. A detailed method of generating the recommendation information in the recommendation provider server 300 will be described below with reference to FIG. 5. Next, the client 200 outputs the recommendation information received from the recommendation provider server 300 together with the identity information of the service provider and the selectable private information and queries the user whether the service provider server 100 provides the requested private information. The user determines whether he/she provides the private information corresponding to the private information requested by the service provider server 100 to the service provider server 100 based on the recommendation information provided through the client 200. Therefore, the client 200 transmits the corresponding private information to the service provider server 100 according to the response from the user (S260) or ends a process of using the specific services provided by the service provider (S280).

Meanwhile, at step S260, the client 200 transmits the corresponding private information to the service provider server 100 and then transmits the response pattern of the user to the recommendation provider server (S270). As described above, the client 200 provides the response pattern of the user to the recommendation provider server 300, thereby making it possible to receive the recommendation information specialized (i.e., reflecting personality) for each user from the recommendation provider server 300. In addition, the client 200 can automate the user response with respect to the response from the recommendation provider server 300 by using the response pattern of the user.

At step S250, when the client 200 transmits the corresponding private information to the service provider server 100, the service provider server 100 receives and verifies the private information transmitted from the client 200. When the private information received from the client 200 meets the list of private information requested, the service provider server 100 provides the specific services requested by the client and otherwise, transmits an error message.

FIG. 5 is a diagram for explaining a process of transmitting the private information to the service provider server based on the recommendation information from the recommendation provider server according to one embodiment of the present invention.

First, the recommendation provider server 300 receives, from the client 200, the list of private information requested by the service provider server 100, the identity information of the service provider server 100, and the recommendation request message including the information request purpose, etc., (S300). Therefore, the recommendation provider server 300 analyzes the level of reliability of the service provider (site) based on the received information and calculates the recommendation values corresponding thereto (S310). In FIG. 3, as described above, the service providers can be divided by the predetermined criteria and the service provider reliability analyzer 312 discriminatively gives the level of reliability to the divided service providers. And, the service provider reliability analyzer 312 calculates the recommendation value to be provided to the client 200 based on the given level of reliability.

Next, the recommendation provider server 300 objectively analyzes the degree of exposure of the private information of the user based on the received information and calculates the recommendation value. For example, providing the private information, such as sex, age, taste, etc., is low in terms of the degree of exposure of the private information. In other words, it does not significantly invade the user's privacy. However, providing a name, an address, a telephone number, etc., exposes the private information, such that the user's privacy can be significantly invaded. The degree of exposure of the private information of the user is analyzed by the predetermined criteria to calculate the recommendation value to be provided to the user (S320).

Subsequently, the recommendation provider server 300 comprehensively analyzes whether the private information requested by the service provider meets the service purpose based on the received information and calculates the recommendation values (S330). For example, in the case of an Internet shopping mall, since articles ordered by the user should be delivered to the home, the user should provide his/her name, home address, telephone number, etc., to the service provider so that the user can obtain the desired service. In the foregoing case, since the service provider requests the private information having a high correlation with the service purpose of the service provider, the recommendation value can be calculated to be high.

Thereafter, the recommendation provider server 300 analyzes the level of reliability of the users on the specific service provider for the previous users and calculates the recommendation value. At this time, the calculated recommendation value is based on the response pattern of the users for the specific service provider (S340). As described above, when there are many cases where the previous users provide the trusted private information to the specific service provider server (site), the level of reliability of the user on the specific service provider is increased and the recommendation provider server 300 analyzes the level of reliability of the users and calculates the recommendation value.

Finally, the recommendation provider server 300 generates the recommendation information reflecting the personal intention of the user based on the recommendation value calculated through each step and the response pattern of the user and transmits it to the client 200 (S350 and S360). At this time, where there is no information on the response pattern of the specific user, the recommendation information is generated based on only the recommendation value calculated by each step.

The present invention can be implemented as a computer-readable code in a computer-readable recording medium. The computer-readable recording media includes all types of recording apparatuses in which data readable by a computer system is stored. Examples of the computer-readable recording media may include a ROM, a RAM, a CD-ROM, a magnetic tape, a floppy disk, an optical data storage, etc. In addition, the computer-readable recording media also include one implemented in the form of a carrier wave (i.e., transmission through the Internet). Further, the computer-readable recording media are distributed on systems connected over the network, and are stored and executed as the computer-readable code by a distribution method.

As described above, the preferred embodiments have been described and illustrated in the drawings and the description. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method of providing recommendation information to a user that wants to share private information, comprising:
allowing a recommendation provider server to receive a recommendation request message including a list of private information of the user requested by a service provider server and identity information of the service provider server from a client;
allowing the recommendation provider server to analyze the received recommendation request message and generate recommendation information to help the user respond to the private information request from the service provider server; and
allowing the recommendation provider server to send the generated recommendation information to the client.

2. The method of providing recommendation information to a user that wants to share private information according to claim 1, wherein generating the recommendation information received from the client, the response pattern of the user to the private information request from the service provider server to reflect personal intention of the user based on the response pattern of the user and generate the recommendation information.

3. The method of providing recommendation information to a user that wants to share private information according to claim 1, wherein generating the recommendation information includes:
allowing the recommendation provider server to analyze the level of reliability of the service provider based on the identity information of the received service provider and calculate recommendation values corresponding to the analyzed level of reliability; and
allowing the recommendation provider server to analyze a degree of exposure of the private information of the user based on the received list of the private information and calculate recommendation values corresponding to the analyzed degree of exposure.

4. The method of providing recommendation information to a user that wants to share private information according to claim 3, wherein the recommendation request message further includes a request purpose of private information from the service provider server; and
the generating the recommendation information further includes analyzing whether the private information of the user requested by the service provider server meets the service purpose provided by the service provider server based on the recommendation request message and calculating recommendation values corresponding thereto.

5. A method of providing recommendation information to a user that wants to share private information, comprising:
allowing a client to send a recommendation request message including a list of private information requested by a service provider server and identity information of the service provider server to a recommendation provider server and request the recommendation information;
allowing the client to receive the recommendation information from the recommendation provider server and display the identity information of the service provider server together with various private information selectable by the user; and
allowing the client to send the selected private information to the service provider server according to the user response.

6. The method of providing recommendation information to a user that wants to share private information according to claim 5, further comprising allowing the client to send the private information to the service provider server and then send the response pattern of the user to the recommendation provider server.

7. A method of providing recommendation information to a user that wants to share private information according claim 6, wherein the client stores and manages the response pattern of the user.

8. A system of providing recommendation information to a user that wants to share private information, comprising:
an interaction unit that transmits a recommendation request message including a list of private information of a user requested by a service provider server and identity information of the service provider server to a recommendation provider server and receives the recommendation information from the recommendation provider server; and
an identity selector that provides the recommendation information together with the identity information of the service provider server and various private information selectable by the user to the user.

9. The system of providing recommendation information to a user that wants to share private information according to claim 8, wherein the identity selector selects any one type of private information without the user response based on the recommendation information and transmits the selected private information to the service provider server.

10. The system of providing recommendation information to a user that wants to share private information according to claim 8, further comprising an identity providing unit that provides the private information of the user to the identity selector according to the request of the identity selector.

11. The system of providing recommendation information to a user that wants to share private information according to claim 10, wherein the identity providing unit stores and manages false private information.

12. A system of providing recommendation information to a user that wants to share private information comprising:
a service provider reliability analyzer that receives the identity information of the service provider server from a client, analyzes the level of reliability of the service provider based on the received identity information, and calculates recommendation values corresponding to the analyzed level of reliability; and
a privacy analyzer that receives a list of private information of the user requested by the service provider server from the client, analyzes a degree of exposure of the private information of the user based on the list, and calculates recommendation values corresponding to the analyzed degree of exposure.

13. The system of providing recommendation information to a user that wants to share private information according to claim 12, further comprising a request compatibility analyzer that receives a request purpose of the private information of the service provider server from the client, analyzes a correlation between it and a list of the private information of the user requested by the service provider server, and calculate recommendation values corresponding thereto.

14. The system of providing recommendation information to a user that wants to share private information according to claim 12, further comprising a response pattern analyzer that receives, from the client, the response pattern of the user to the private information request from the service provider server and analyzes the response pattern of the user.
